(19) United States
(12) Patent Application Publication
(10) Pub. No.: US 2022/0100964 A1
(43) Pub. Date: Mar. 31, 2022

(54) DEEP LEARNING BASED DOCUMENT SPLITTER

(71) Applicant: UiPath, Inc., New York, NY (US)

(72) Inventors: Rukma TALWADKER, Bengaluru (IN); Radhakrishnan IYER, Chennai (IN)

(73) Assignee: UiPath, Inc., New York, NY (US)

(21) Appl. No.: 17/075,731

(22) Filed: Oct. 21, 2020

(30) Foreign Application Priority Data
Sep. 25, 2020 (IN) 202011041647

(51) Int. Cl. G06F 40/30; G06N 3/08; G06N 3/04; G06F 16/93; G06F 40/279; G06F 40/166

(52) U.S. Cl. CPC G06F 40/30; G06N 3/08; G06F 40/166; G06F 16/93; G06F 40/279; G06N 3/0445

(57) ABSTRACT

Systems and methods for splitting an electronic file into sub-documents are provided. The electronic file is received. Portions of the electronic file are classified using a trained machine learning based model. The classifications represent relative positions of the portions within sub-documents of the electronic file. The electronic file is split into the sub-documents based on the relative positions of the portions. The sub-documents are output.

### TECHNICAL FIELD

The present invention relates generally to robotic process automation (RPA), and more particularly to a deep learning based document splitter for document processing in RPA.

### BACKGROUND

Robotic process automation (RPA) is a form of process automation that uses software robots to automate workflows. RPA may be implemented to automate repetitive and/or labor-intensive tasks to reduce costs and increase efficiency. One important task in RPA is document processing. Typically, document processing is performed on an electronic computer file comprising a plurality of sub-documents. For example, such an electronic computer file may include sub-documents corresponding to invoices, reports, insurance forms, etc. In order to perform many document processing tasks, such as, e.g., document digitization, the electronic computer file must be split into the plurality of sub-documents.

Conventional approaches for document splitting of an electronic computer file rely on the identification of keywords in the electronic computer file. However, such reliance on keyword identification by conventional document splitting approaches have a number of deficiencies, such as, e.g., requiring the manual identification of keywords, difficulty in locating keywords in the electronic computer file, keyword collision where multiple sub-documents include identical keywords, and human error in keyword assignment.

### BRIEF SUMMARY OF THE INVENTION

In accordance with one or more embodiments, systems and methods for splitting an electronic file into sub-documents using a trained machine learning based model are provided. The electronic file is received. Portions of the electronic file are classified using a trained machine learning based model. The classifications represent relative positions of the portions within sub-documents of the electronic file. The electronic file is split into the sub-documents based on the relative positions of the portions. The sub-documents are output.

In one embodiment, the classifications representing the relative positions of the portions within the sub-documents of the electronic file include a classification representing a first portion of a sub-document, a classification representing a last portion of a sub-document, and a classification representing a portion of a sub-document between the first portion and the last portion. The portions of the electronic file may be classified by mapping features of interest extracted from each of the portions of the electronic file to the classifications. The features of interest include one or more of a word cloud, a page number, or text related features.

In one embodiment, misclassified portions are detected from the classified portions using a statistical checker and the misclassified portions are presented to a user for manual classification.

In one embodiment, the electronic file is split immediately prior to each portion classified as being a first portion of a sub-document. The portions of the electronic file may correspond to pages of the electronic file.

In one embodiment, the trained machine learning based model is a trained deep learning model. The trained machine learning based model may be based on one of a LSTM (long short-term memory) architecture, a Bi-LSTM (bi-directional LSTM) architecture, or a seq2seq (sequence-to-sequence) architecture.

In one embodiment, the sub-documents are classified using a classifier.

These and other advantages of the invention will be apparent to those of ordinary skill in the art by reference to the following detailed description and the accompanying drawings.

### BRIEF DESCRIPTION OF THE DRAWINGS

FIG. 1 is an architectural diagram illustrating a robotic process automation (RPA) system, according to an embodiment of the invention;

FIG. 2 is an architectural diagram illustrating an example of a deployed RPA system, according to an embodiment of the invention;

FIG. 3 is an architectural diagram illustrating a simplified deployment example of a RPA system, according to an embodiment of the invention;

FIG. 4 shows a method for splitting an electronic computer file into sub-documents, according to an embodiment of the invention;

FIG. 5 a shows block diagram representation of an electronic file, according to an embodiment of the invention;

FIG. 6 shows a method for training a machine learning based model to classify portions of an electronic file, according to an embodiment of the invention; and

FIG. 7 is a block diagram of a computing system according to an embodiment of the invention.

### DETAILED DESCRIPTION

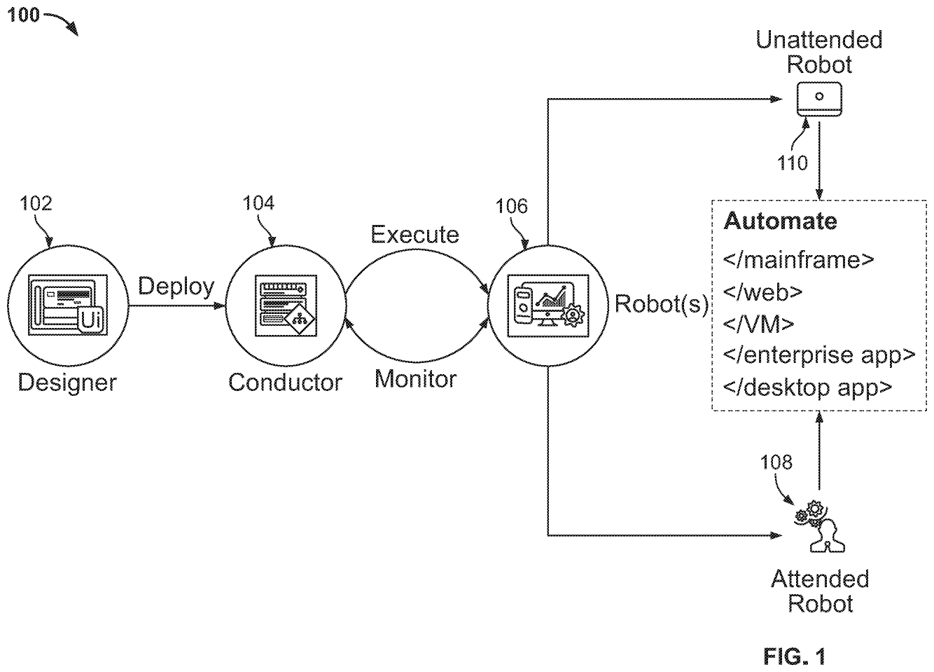

Robotic process automation (RPA) is used for automating workflows and processes. FIG. 1 is an architectural diagram of an RPA system 100, in accordance with one or more embodiments. As shown in FIG. 1, RPA system 100 includes a designer 102 to allow a developer to design automation processes. More specifically, designer 102 facilitates the development and deployment of RPA processes and robots for performing activities in the processes. Designer 102 may provide a solution for application integration, as well as automating third-party applications, administrative Information Technology (IT) tasks, and business processes for contact center operations. One commercial example of an embodiment of designer 102 is UiPath Studio™.

In designing the automation of rule-based processes, the developer controls the execution order and the relationship between a custom set of steps developed in a process, defined herein as “activities.” Each activity may include an action, such as clicking a button, reading a file, writing to a log panel, etc. In some embodiments, processes may be nested or embedded.

Some types of processes may include, but are not limited to, sequences, flowcharts, Finite State Machines (FSMs), and/or global exception handlers. Sequences may be particularly suitable for linear processes, enabling flow from one activity to another without cluttering a process. Flowcharts may be particularly suitable to more complex business logic, enabling integration of decisions and connection of activities in a more diverse manner through multiple branching logic operators. FSMs may be particularly suitable for large workflows. FSMs may use a finite number of states in their execution, which are triggered by a condition (i.e., transition) or an activity. Global exception handlers may be particularly suitable for determining workflow behavior when encountering an execution error and for debugging processes.

Once a process is developed in designer 102, execution of business processes is orchestrated by a conductor 104, which orchestrates one or more robots 106 that execute the processes developed in designer 102. One commercial example of an embodiment of conductor 104 is UiPath Orchestrator™. Conductor 220 facilitates management of the creation, monitoring, and deployment of resources in an RPA environment. In one example, conductor 104 is a web application. Conductor 104 may also function as an integration point with third-party solutions and applications.

Conductor 104 may manage a fleet of RPA robots 106 by connecting and executing robots 106 from a centralized point. Conductor 104 may have various capabilities including, but not limited to, provisioning, deployment, configuration, queueing, monitoring, logging, and/or providing interconnectivity. Provisioning may include creation and maintenance of connections between robots 106 and conductor 104 (e.g., a web application). Deployment may include assuring the correct delivery of package versions to assigned robots 106 for execution. Configuration may include maintenance and delivery of robot environments and process configurations. Queueing may include providing management of queues and queue items. Monitoring may include keeping track of robot identification data and maintaining user permissions. Logging may include storing and indexing logs to a database (e.g., an SQL database) and/or another storage mechanism (e.g., ElasticSearch®, which provides the ability to store and quickly query large datasets). Conductor 104 may provide interconnectivity by acting as the centralized point of communication for third-party solutions and/or applications.

Robots 106 are execution agents that run processes built in designer 102. One commercial example of some embodiments of robots 106 is UiPath Robots™. Types of robots 106 may include, but are not limited to, attended robots 108 and unattended robots 110. Attended robots 108 are triggered by a user or user events and operate alongside a human user on the same computing system. Attended robots 108 may help the human user accomplish various tasks, and may be triggered directly by the human user and/or by user events. In the case of attended robots, conductor 104 may provide centralized process deployment and a logging medium. In certain embodiments, attended robots 108 can only be started from a “robot tray” or from a command prompt in a web application. Unattended robots 110 operate in an unattended mode in virtual environments and can be used for automating many processes, e.g., for high-volume, back-end processes and so on. Unattended robots 110 may be responsible for remote execution, monitoring, scheduling, and providing support for work queues. Both attended and unattended robots may automate various systems and applications including, but not limited to, mainframes, web applications, VMs, enterprise applications (e.g., those produced by SAP®, SalesForce®, Oracle®, etc.), and computing system applications (e.g., desktop and laptop applications, mobile device applications, wearable computer applications, etc.).

In some embodiments, robots 106 install the Microsoft Windows® Service Control Manager (SCM)-managed service by default. As a result, such robots 106 can open interactive Windows® sessions under the local system account, and have the rights of a Windows® service. In some embodiments, robots 106 can be installed in a user mode with the same rights as the user under which a given robot 106 has been installed.

Robots 106 in some embodiments are split into several components, each being dedicated to a particular task. Robot components in some embodiments include, but are not limited to, SCM-managed robot services, user mode robot services, executors, agents, and command line. SCM-managed robot services manage and monitor Windows® sessions and act as a proxy between conductor 104 and the execution hosts (i.e., the computing systems on which robots 106 are executed). These services are trusted with and manage the credentials for robots 106. A console application is launched by the SCM under the local system. User mode robot services in some embodiments manage and monitor Windows® sessions and act as a proxy between conductor 104 and the execution hosts. User mode robot services may be trusted with and manage the credentials for robots 106. A Windows® application may automatically be launched if the SCM-managed robot service is not installed. Executors may run given jobs under a Windows® session (e.g., they may execute workflows) and they may be aware of per-monitor dots per inch (DPI) settings. Agents may be Windows® Presentation Foundation (WPF) applications that display the available jobs in the system tray window. Agents may be a client of the service. Agents may request to start or stop jobs and change settings. Command line is a client of the service and is a console application that can request to start jobs and waits for their output. Splitting robot components can help developers, support users, and enable computing systems to more easily run, identify, and track what each robot component is executing. For example, special behaviors may be configured per robot component, such as setting up different firewall rules for the executor and the service. As a further example, an executor may be aware of DPI settings per monitor in some embodiments and, as a result, workflows may be executed at any DPI regardless of the configuration of the computing system on which they were created.

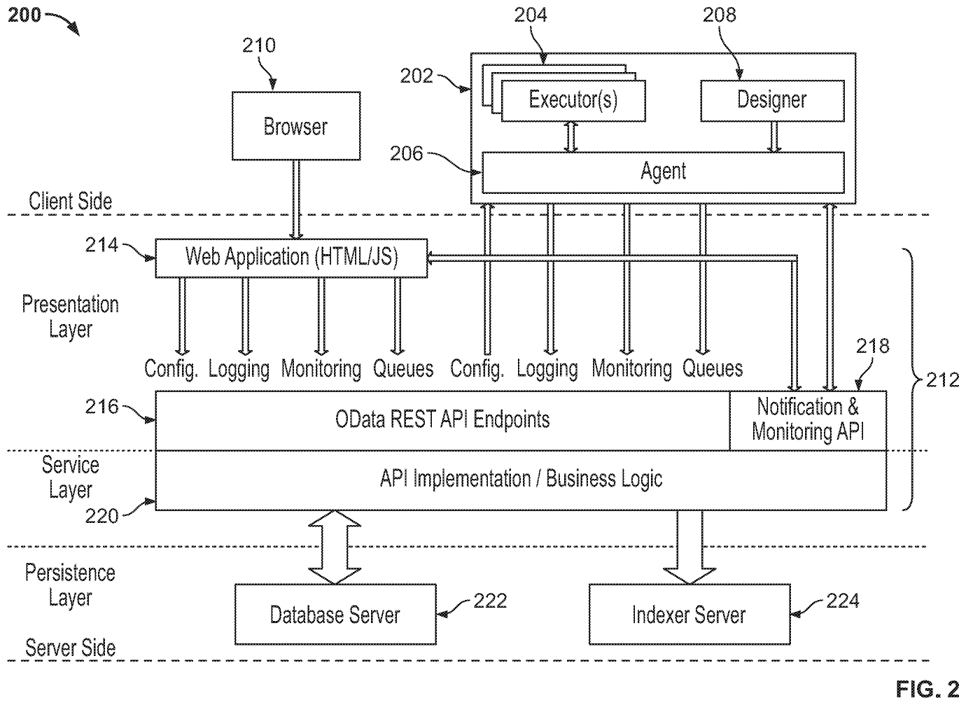

FIG. 2 shows an RPA system 200, in accordance with one or more embodiments. RPA system 200 may be, or may be part of, RPA system 100 of FIG. 1. It should be noted that the “client side”, the “server side”, or both, may include any desired number of computing systems without deviating from the scope of the invention.

As shown on the client side in this embodiment, computing system 202 includes one or more executors 204, agent 206, and designer 208. In other embodiments, designer 208 may not be running on the same computing system 202. An executor 204 (which may be a robot component as described above) runs a process and, in some embodiments, multiple business processes may run simultaneously. In this example, agent 206 (e.g., a Windows® service) is the single point of contact for managing executors 204.

In some embodiments, a robot represents an association between a machine name and a username. A robot may manage multiple executors at the same time. On computing systems that support multiple interactive sessions running simultaneously (e.g., Windows® Server 2012), multiple robots may be running at the same time (e.g., a high density (HD) environment), each in a separate Windows® session using a unique username.

Agent 206 is also responsible for sending the status of the robot (e.g., periodically sending a “heartbeat” message indicating that the robot is still functioning) and downloading the required version of the package to be executed. The communication between agent 206 and conductor 212 is initiated by agent 206 in some embodiments. In the example of a notification scenario, agent 206 may open a WebSocket channel that is later used by conductor 212 to send commands to the robot (e.g., start, stop, etc.).

As shown on the server side in this embodiment, a presentation layer comprises web application 214, Open Data Protocol (OData) Representative State Transfer (REST) Application Programming Interface (API) endpoints 216 and notification and monitoring API 218. A service layer on the server side includes API implementation/business logic 220. A persistence layer on the server side includes database server 222 and indexer server 224. Conductor 212 includes web application 214, OData REST API endpoints 216, notification and monitoring API 218, and API implementation/business logic 220.

In various embodiments, most actions that a user performs in the interface of conductor 212 (e.g., via browser 210) are performed by calling various APIs. Such actions may include, but are not limited to, starting jobs on robots, adding/removing data in queues, scheduling jobs to run unattended, and so on. Web application 214 is the visual layer of the server platform. In this embodiment, web application 214 uses Hypertext Markup Language (HTML) and JavaScript (JS). However, any desired markup languages, script languages, or any other formats may be used without deviating from the scope of the invention. The user interacts with web pages from web application 214 via browser 210 in this embodiment in order to perform various actions to control conductor 212. For instance, the user may create robot groups, assign packages to the robots, analyze logs per robot and/or per process, start and stop robots, etc.

In addition to web application 214, conductor 212 also includes a service layer that exposes OData REST API endpoints 216 (or other endpoints may be implemented without deviating from the scope of the invention). The REST API is consumed by both web application 214 and agent 206. Agent 206 is the supervisor of one or more robots on the client computer in this exemplary configuration.

The REST API in this embodiment covers configuration, logging, monitoring, and queueing functionality. The configuration REST endpoints may be used to define and configure application users, permissions, robots, assets, releases, and environments in some embodiments. Logging REST endpoints may be useful for logging different information, such as errors, explicit messages sent by the robots, and other environment-specific information, for example. Deployment REST endpoints may be used by the robots to query the package version that should be executed if the start job command is used in conductor 212. Queueing REST endpoints may be responsible for queues and queue item management, such as adding data to a queue, obtaining a transaction from the queue, setting the status of a transaction, etc. Monitoring REST endpoints monitor web application 214 and agent 206. Notification and monitoring API 218 may be REST endpoints that are used for registering agent 206, delivering configuration settings to agent 206, and for sending/receiving notifications from the server and agent 206. Notification and monitoring API 218 may also use WebSocket communication in some embodiments.

The persistence layer on the server side includes a pair of servers in this illustrative embodiment—database server 222 (e.g., a SQL server) and indexer server 224. Database server 222 in this embodiment stores the configurations of the robots, robot groups, associated processes, users, roles, schedules, etc. This information is managed through web application 214 in some embodiments. Database server 222 may also manage queues and queue items. In some embodiments, database server 222 may store messages logged by the robots (in addition to or in lieu of indexer server 224). Indexer server 224, which is optional in some embodiments, stores and indexes the information logged by the robots. In certain embodiments, indexer server 224 may be disabled through configuration settings. In some embodiments, indexer server 224 uses ElasticSearch®, which is an open source project full-text search engine. Messages logged by robots (e.g., using activities like log message or write line) may be sent through the logging REST endpoint(s) to indexer server 224, where they are indexed for future utilization.

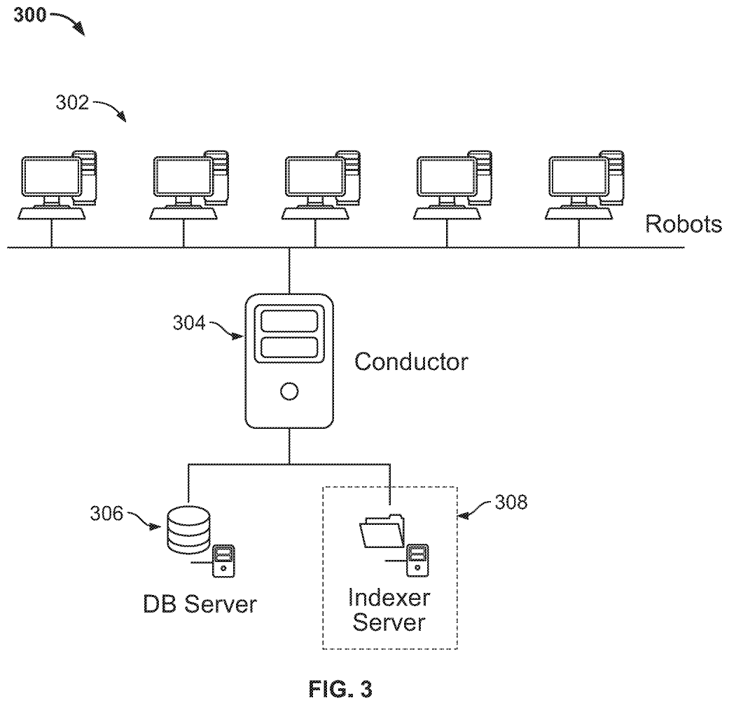

FIG. 3 is an architectural diagram illustrating a simplified deployment example of RPA system 300, in accordance with one or more embodiments. In some embodiments, RPA system 300 may be, or may include, RPA systems 100 and/or 200 of FIGS. 1 and 2, respectively. RPA system 300 includes multiple client computing systems 302 running robots. Computing systems 302 are able to communicate with a conductor computing system 304 via a web application running thereon. Conductor computing system 304, in turn, communicates with database server 306 and an optional indexer server 308. With respect to FIGS. 2 and 3, it should be noted that while a web application is used in these embodiments, any suitable client/server software may be used without deviating from the scope of the invention. For instance, the conductor may run a server-side application that communicates with non-web-based client software applications on the client computing systems.

RPA system 100 of FIG. 1, RPA system 200 of FIG. 2, and/or RPA system 300 of Figure may be implemented to automatically perform various RPA tasks using one or more RPA robots. One important RPA task is document processing. Many document processing tasks, such as, e.g., document digitization, involves splitting electronic files into various sub-documents in order to perform further downstream document processing on the sub-documents. Each sub-document may correspond to, e.g., an invoice, a report, an insurance form, etc. Embodiments described herein provide for the splitting of an electronic file into sub-documents using a trained machine learning based model. Each portion of the electronic file is labelled using a generically trained machine learning based model. This labelling helps to decide the inclusivity of the portion between two consecutive sub-documents. Advantageously, embodiments described herein provide for more accurate document splitting results without the deficiencies of conventional keyword based document splitting approaches, thereby resulting in higher quality downstream document processing.

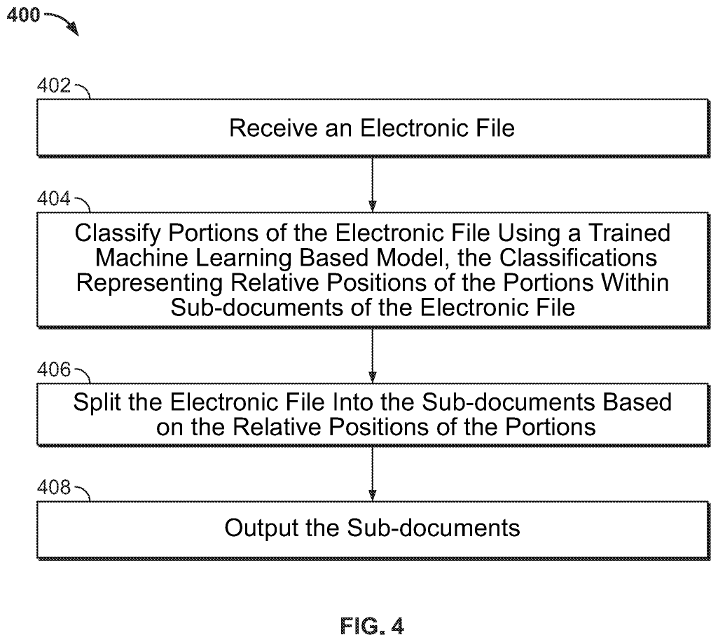

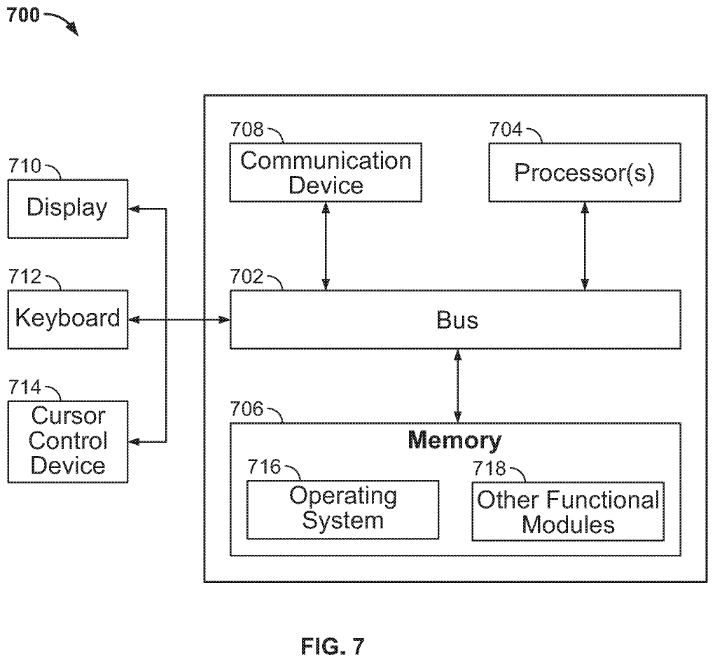

FIG. 4 shows a method 400 for splitting an electronic computer file into sub-documents, in accordance with one or more embodiments. Method 400 may be performed by one or more suitable computing devices, such as, e.g., computing system 700 of FIG. 7.

At step 402, an electronic file is received. The electronic file is a computer file of any suitable format, such as, e.g., PDF (portable document format). The electronic file may be received by loading a previously stored electronic file from a storage or memory of a computer system or by receiving an electronic file transmitted from a remote computer system.

The electronic file includes a number of portions. In one embodiment, each portion of the electronic file corresponds to a page of the electronic file. However, it should be understood that the portions of the electronic file may be any suitable portions, such as, e.g., paragraphs of the electronic file, sections of the electronic file, etc. The portions of the electronic file are associated with sub-documents of various document types. For example, the portions may be associated with such sub-documents as, e.g., invoices, reports, insurance forms, or any other suitable sub-document.

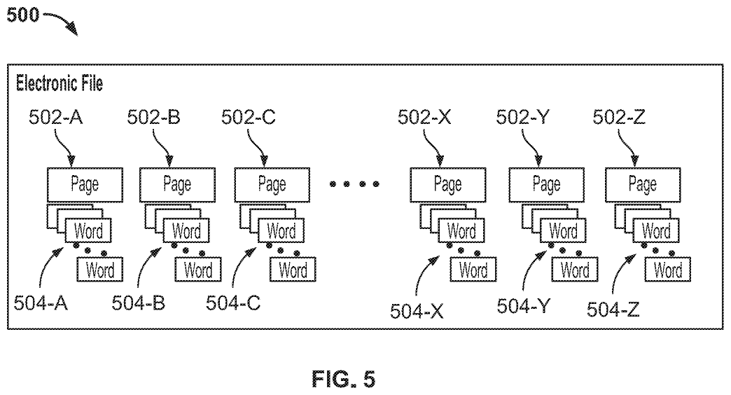

FIG. 5 shows a block diagram representation of an electronic file 500, in accordance with one or more embodiments. Electronic file 500 may be the electronic file received at step 402 of FIG. 4. Electronic file 500 comprises pages 502-A, 502-B, 502-C, . . . 502-X, 502-Y, and 502-Z (collectively referred to herein as pages 502). Pages 502 may comprise any number of pages of electronic file 500. While pages 502 are represented as pages of electronic file 500, it should be understood that pages 502 may be any portion (e.g., paragraphs, sections, etc.) of electronic file 502. Each page 502-A, 502-B, 502-C, . . . 502-X, 502-Y, and 502-Z respectively includes a plurality of words 504-A, 504-B, 504-C, . . . 504-X, 504-Y, and 504-Z (collectively referred to herein as words 504).

Returning to FIG. 4, at step 404, portions of the electronic file are classified using a trained machine learning based model. The classifications represent relative positions of the portions within sub-documents of the electronic file. In one embodiment, the classifications are in an 10B (inside-outside-begin or inside-other-begin) format to represent the relative positions of the portions within the sub-documents as one of an inside classification, an outside (or other) classification, or a begin classification, where the begin classification represents a first portion of a sub-document, the outside classification represents a last portion of a sub-document, and the inside classification represents a portion between the first portion and the last portion. However, the classifications may include any other suitable classification that represents relative position of portion within a sub-document.

The trained machine learning based model receives the electronic file as input. Each portion of the electronic file may have any number of words. However, the trained machine learning based model considers only a predetermined number of words (including their meta-features), which is determined empirically while training the machine learning based model. Accordingly, for portions that have less than the predetermined number of words, those portions are null padded by appending null words until the predetermined number of words is reached. For portions that have more than the predetermined number of words, words are selected for consideration by the trained machine learning based model from a top of a portion downwards and from a bottom of the portion upwards until the predetermined number of words is reached. The words may be equally selected from the top and the bottom of a portion, or may be weighted for selecting words more from the top of a portion or more from the bottom of a portion. For example, if the predetermined number of words is 250 per page and a particular page has 400 words, then 70% of the 250 predetermined number of words may be selected from the top of the page while 30% of the 250 predetermined number of words may be selected from the bottom of the page. In this example, 175 words would be selected from the top of the page while 75 words would be selected from the bottom of the page. By selecting words from the top and the bottom of a portion, metadata and/or characteristics of the text carries preference over the actual words and valuable information in the header and footer of a portion (e.g., page) is retained. The predetermined number of words may be determined during a prior offline or training stage of the machine learning based model. In one embodiment, the predetermined number of words is determined as the median number of words in the portions of a training data set.

The trained machine learning based model extracts features of interest from each portion of the electronic file and maps the extracted features of interest for each of the portions to a classification to thereby classify the portions of the electronic file. The features of interest may be represented in any suitable format. In one embodiment, the features of interest are included as part of a tensor. For example, the tensor may be a 3D tensor comprising a list of portions as the first dimension, words per portion as the second dimension, and the set of text related features for each word as the third dimension.

The features of interest may be DOM (document object model) related features. For example, in one embodiment, the features of interest include a word cloud for each portion of the electronic file. A word cloud is a representation of the scope of a portion based on the words in that portion. The word cloud is generated based on word embeddings, which are numeric vector representations of words in a portion extracted using, e.g., the GloVe (global vectors for word representation) algorithm. In another embodiment, the features of interest include a page number or length. For example, the page number “page 2 of 5” may be identified in the footer or header of a page to classify that page as inside a sub-document with 5 total pages. In another embodiment, the features of interest include text related features. The text related features may include any feature related to the text of a portion, such as, e.g., a letter case of text (e.g., lower case, upper case, title), a font or format of text (e.g., height, width, font style, length of words (e.g., determined using a bounding box), distance from the top or bottom of the text), a section type (e.g., paragraph, table, header), or any other suitable text related features. In one embodiment, the features of interest extracted from the electronic file are normalized before being mapped to a classification by the trained machine learning based model.

The output of the trained machine learning based model may be a classification vector identifying a classification for each portion of the electronic file. In one embodiment, the classification vector is a one-hot encoded classification vector in the format [inside outside begin], such that a 1 in the vector denotes a positive classification and a 0 in the vector denotes a negative classification. For example, a vector of [1 0 0] for a portion denotes that the portion is classified as inside, a vector of [0 1 0] denotes that the portion is classified as outside, and a vector of [0 0 1] denotes that the portion is classified as begin. The classification vector comprises a vector for each portion in the electronic file. In one example, the classification vector is:

[[0 0 1], [1 0 0], [1 0 0], [0 1 0]]

which denotes that the first portion is classified as begin, the second portion is classified as inside, the third portion is classified as inside, and the fourth portion is classified as outside.

The trained machine learning based model may be any suitable machine learning based model, such as, e.g., a neural network based model or artificial neural network based model. In one embodiment, the machine learning based model is a deep learning based model. In one embodiment, the machine learning based model may be implemented using an LSTM (long short-term memory) RNN (recurrent neural network) architecture. The LSTM RNN provides long term memory controlled by opening or closing an input gate, an output gate, and/or a forget gate. The LSTM RNN thus enables storage and subsequent retrieval of encoded features to thereby provide for classification of portions of the electronic file based on encoded features from the classification of previous portions of the electronic file. In another embodiment, the machine learning based model may be implemented using a Bi-LSTM (bi-directional LSTM) RNN architecture. The Bi-LSTM RNN enables bidirectional communication to provide for classification of portions of the electronic file based on encoded features from the classification of previous portions, as well as encoded features from the classification of next portions in the electronic file. In another embodiment, the machine learning based model may be implemented using a seq2seq (sequence-to-sequence) network architecture.

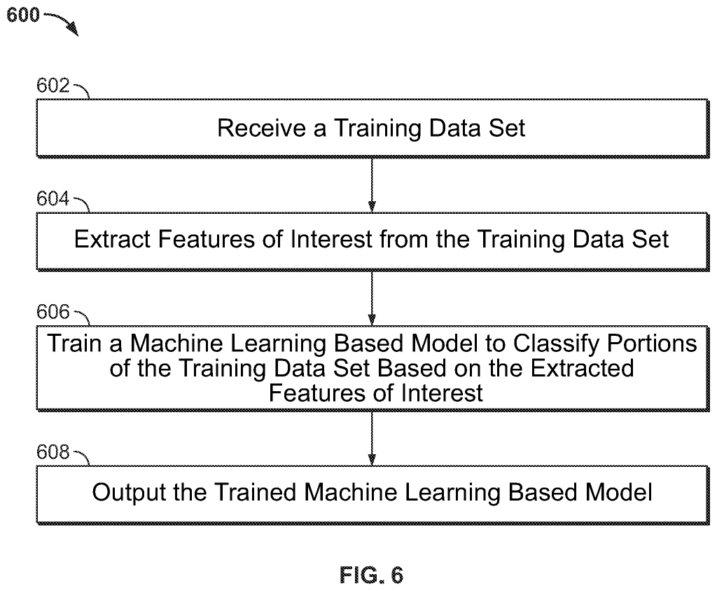

The machine learning based model is trained to classify portions of the electronic file using a training data set during a prior offline or training phase. In one embodiment, the machine learning based model is trained according to method 600 of FIG. 6, described in detail below. Once trained, the trained machine learning based model is applied at step 404 on unseen data to classify portions of the electronic file during an online or prediction phase.

In one embodiment, after classifying each of the portions of the electronic file by the trained machine learning based model, a statistical checker is applied to detect misclassified portions. The detection is performed based on the assumption that softmax scores for correct predictions during the prior training phase follow a Gaussian or normal distribution. During the prior training phase, for each classification, assuming a Gaussian distribution, the min, max, mean, and standard deviation of the distribution is calculated using the observed softmax values. For a new prediction (e.g., for a classification of a portion at step 404), the softmaxₚ is obtained from the trained machine learning based model. The threshold or cut-off value is calculated according to Equation (1) as follows:

Threshold=CEILING(mean−standard deviation) Equation (1)

where CEILING is the rounding up of the value to the nearest integer and the mean and the standard deviation are calculated during the prior training phase. The statistical checker provides guidance based on the softmaxₚ and the calculated threshold value. The guidance may be binary guidance such that if the value of softmaxₚ is less than the calculated threshold value, the predicted classification by the trained machine learning based model is discarded; otherwise the predicted classification is validated. Where the statistical checker identifies misclassified portions, the electronic file with the misclassified portions may be presented to a user for manual classification.

At step 406, the electronic file is split into the sub-documents based on the relative positions of the portions. Each sub-document comprises a sequence of one or more portions. In one embodiment, the electronic file is split immediately prior to each portion classified as being a first portion of a sub-document. For example, the electronic file may be split immediately prior to each portion with a begin classification. Accordingly, the electronic file may be split by, for example, extracting sequences of portions between each split from the electronic file as the sub-documents.

It should be understood that the sequence of portions for each sub-document does not necessary include a portion classified as begin, one or more portions classified as inside, and a portion classified as inside. For example, a sub-document comprising a single portion would have one portion classified as begin. In another example, a sub-document comprising a sequence of two portions would have one portion classified as begin and the other portion classified as outside.

At step 408, the sub-documents are output. The sub-documents may be output by, for example, displaying the sub-documents on a display device of a computer system (e.g., display 710 of FIG. 7) or by storing the sub-documents on a memory or storage of a computer system (e.g., memory 706 of FIG. 7).

In one embodiment, the sub-documents are output for further document processing for performing an RPA task. In one example, the sub-documents are output to a classifier for classifying the sub-documents according to a document type, such as, e.g., invoices, reports, insurance forms, or any other suitable document type. The classifier may be any suitable classifier. In one example, the classifier is a machine learning based classifier.

FIG. 6 shows a method 600 for training a machine learning based model to classify portions of an electronic file, in accordance with one or more embodiments. The steps of method 600 are performed during an offline or training phase. Once trained, the trained machine learning based model is applied to classify portions of an electronic file during an online or prediction phase. In one embodiment, the trained machine learning based model trained according to method 600 may be applied during a prediction phase at step 404 of FIG. 4 to classify portions of an electronic file. It should be understood that features and embodiments described with respect to applying the trained machine learning based model (e.g., during a prediction phase during method 400 of FIG. 4) may also be applicable for training the machine learning based model (e.g., during a training phase during method 600). Method 600 may be performed by one or more suitable computing devices, such as, e.g., computing system 700 of FIG. 7.

At step 602, a training data set is received. The training data set comprises one or more electronic training files, each comprising one or more training sub-documents. The each training sub-document is identified within the training data set, enabling the machine learning based model to infer the relative position of portions within sub-documents without requiring manual annotation.

At step 604, features of interest are extracted from the training data set. The features of interest may include the features of interest described above with respect to step 404 of FIG. 4. For example, the features of interest may include a word cloud for the portions of the training sub-documents, a page number or length, or text related features.

At step 606, a machine learning based model is trained to classify portions of the training data set based on the extracted features of interest. The machine learning based model may be a deep learning based model or any other suitable machine learning based model. In one embodiment, the machine learning based model may be implemented using an LSTM RNN, a Bi-LSTM RNN, or a seq2seq network architecture. During training, the machine learning based model learns a mapping between the extracted features of interest and a classification. In one embodiment, the classification is in an 10B format, but may any other suitable classification that represents relative positions of the portions within sub-documents.

At step 608, the trained machine learning based model is output. The trained machine learning based model may be output by, for example, storing the trained machine learning based model on a memory or storage of a computer system (e.g., memory 706 of FIG. 7). The trained machined learning based model may then be retrieved from memory for classifying portions of an electronic file during an online or prediction phase, such as, e.g., at step 404 of FIG. 4.

Embodiments described herein were experimentally validated using available data sets totaling 540 sub-documents with approximately 52,000 pages. The experimental validation resulted in a training accuracy of 88% and a validation accuracy of 83%.

Advantageously, embodiments described herein provide for splitting an electronic file into subdocuments using a trained machine learning based model without requiring prior annotations or splitting of the training data set for training the machine learning based model. Once trained, retraining of the trained machine learning based model is not required before being applied during the prediction phase. Embodiments described herein provide a cost effective solution for splitting an electronic file without requiring manual validation by a user, and also avoid the deficiencies of conventional keyword based document splitting approaches.

FIG. 7 is a block diagram illustrating a computing system 700 configured to execute the methods, workflows, and processes described herein, including the methods shown in FIGS. 4 and 6, according to an embodiment of the present invention. In some embodiments, computing system 700 may be one or more of the computing systems depicted and/or described herein. Computing system 700 includes a bus 702 or other communication mechanism for communicating information, and processor(s) 704 coupled to bus 702 for processing information. Processor(s) 704 may be any type of general or specific purpose processor, including a Central Processing Unit (CPU), an Application Specific Integrated Circuit (ASIC), a Field Programmable Gate Array (FPGA), a Graphics Processing Unit (GPU), multiple instances thereof, and/or any combination thereof. Processor(s) 704 may also have multiple processing cores, and at least some of the cores may be configured to perform specific functions. Multi-parallel processing may be used in some embodiments.

Computing system 700 further includes a memory 706 for storing information and instructions to be executed by processor(s) 704. Memory 706 can be comprised of any combination of Random Access Memory (RAM), Read Only Memory (ROM), flash memory, cache, static storage such as a magnetic or optical disk, or any other types of non-transitory computer-readable media or combinations thereof. Non-transitory computer-readable media may be any available media that can be accessed by processor(s) 704 and may include volatile media, non-volatile media, or both. The media may also be removable, non-removable, or both.

Additionally, computing system 700 includes a communication device 708, such as a transceiver, to provide access to a communications network via a wireless and/or wired connection according to any currently existing or future-implemented communications standard and/or protocol.

Processor(s) 704 are further coupled via bus 702 to a display 710 that is suitable for displaying information to a user. Display 710 may also be configured as a touch display and/or any suitable haptic I/O device.

A keyboard 712 and a cursor control device 714, such as a computer mouse, a touchpad, etc., are further coupled to bus 702 to enable a user to interface with computing system. However, in certain embodiments, a physical keyboard and mouse may not be present, and the user may interact with the device solely through display 710 and/or a touchpad (not shown). Any type and combination of input devices may be used as a matter of design choice. In certain embodiments, no physical input device and/or display is present. For instance, the user may interact with computing system 700 remotely via another computing system in communication therewith, or computing system 700 may operate autonomously.

Memory 706 stores software modules that provide functionality when executed by processor(s) 704. The modules include an operating system 716 for computing system 700 and one or more additional functional modules 718 configured to perform all or part of the processes described herein or derivatives thereof.

One skilled in the art will appreciate that a “system” could be embodied as a server, an embedded computing system, a personal computer, a console, a personal digital assistant (PDA), a cell phone, a tablet computing device, a quantum computing system, or any other suitable computing device, or combination of devices without deviating from the scope of the invention. Presenting the above-described functions as being performed by a “system” is not intended to limit the scope of the present invention in any way, but is intended to provide one example of the many embodiments of the present invention. Indeed, methods, systems, and apparatuses disclosed herein may be implemented in localized and distributed forms consistent with computing technology, including cloud computing systems.

It should be noted that some of the system features described in this specification have been presented as modules, in order to more particularly emphasize their implementation independence. For example, a module may be implemented as a hardware circuit comprising custom very large scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like. A module may also be at least partially implemented in software for execution by various types of processors. An identified unit of executable code may, for instance, include one or more physical or logical blocks of computer instructions that may, for instance, be organized as an object, procedure, or function. Nevertheless, the executables of an identified module need not be physically located together, but may include disparate instructions stored in different locations that, when joined logically together, comprise the module and achieve the stated purpose for the module. Further, modules may be stored on a computer-readable medium, which may be, for instance, a hard disk drive, flash device, RAM, tape, and/or any other such non-transitory computer-readable medium used to store data without deviating from the scope of the invention. Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

The foregoing merely illustrates the principles of the disclosure. It will thus be appreciated that those skilled in the art will be able to devise various arrangements that, although not explicitly described or shown herein, embody the principles of the disclosure and are included within its spirit and scope. Furthermore, all examples and conditional language recited herein are principally intended to be only for pedagogical purposes to aid the reader in understanding the principles of the disclosure and the concepts contributed by the inventor to furthering the art, and are to be construed as being without limitation to such specifically recited examples and conditions. Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future.

1. A computer-implemented method comprising:
classifying portions of an electronic file using a trained machine learning based model, the classifications representing relative positions of the portions within sub-documents of the electronic file;
splitting the electronic file into the sub-documents based on the relative positions of the portions; and
outputting the sub-documents.

2. The computer-implemented method of claim 1, wherein the classifications representing the relative positions of the portions within the sub-documents of the electronic file comprise a classification representing a first portion of a sub-document, a classification representing a last portion of a sub-document, and a classification representing a portion of a sub-document between the first portion and the last portion.

3. The computer-implemented method of claim 1, wherein classifying portions of an electronic file using a trained machine learning based model comprises:
mapping features of interest extracted from each of the portions of the electronic file to the classifications, the features of interest comprising one or more of a word cloud, a page number, or text related features.

4. The computer-implemented method of claim 1, wherein classifying portions of an electronic file using a trained machine learning based model further comprises:
detecting misclassified portions from the classified portions using a statistical checker; and
presenting the misclassified portions to a user for manual classification.

5. The computer-implemented method of claim 1, wherein splitting the electronic file into the sub-documents based on the relative positions of the portions comprises:
splitting the electronic file immediately prior to each portion classified as being a first portion of a sub-document.

6. The computer-implemented method of claim 1, wherein the portions of the electronic file correspond to pages of the electronic file.

7. The computer-implemented method of claim 1, wherein the trained machine learning based model comprises a trained deep learning model.

8. The computer-implemented method of claim 1, wherein the trained machine learning based model is based on one of a LSTM (long short-term memory) architecture, a Bi-LSTM (bi-directional LSTM) architecture, or a seq2seq (sequence-to-sequence) architecture.

9. The computer-implemented method of claim 1, further comprising:
classifying the sub-documents using a classifier.

10. An apparatus comprising:
a memory storing computer instructions; and
at least one processor configured to execute the computer instructions, the computer instructions configured to cause the at least one processor to perform operations of:
classifying portions of an electronic file using a trained machine learning based model, the classifications representing relative positions of the portions within sub-documents of the electronic file;
splitting the electronic file into the sub-documents based on the relative positions of the portions; and
outputting the sub-documents.

11. The apparatus of claim 10, wherein the classifications representing the relative positions of the portions within the sub-documents of the electronic file comprise a classification representing a first portion of a sub-document, a classification representing a last portion of a sub-document, and a classification representing a portion of a sub-document between the first portion and the last portion.

12. The apparatus of claim 10, wherein classifying portions of an electronic file using a trained machine learning based model comprises:
mapping features of interest extracted from each of the portions of the electronic file to the classifications, the features of interest comprising one or more of a word cloud, a page number, or text related features.

13. The apparatus of claim 10, wherein classifying portions of an electronic file using a trained machine learning based model further comprises:
detecting misclassified portions from the classified portions using a statistical checker; and
presenting the misclassified portions to a user for manual classification.

14. The apparatus of claim 10, wherein splitting the electronic file into the sub-documents based on the relative positions of the portions comprises:
splitting the electronic file immediately prior to each portion classified as being a first portion of a sub-document.

15. A computer program embodied on a non-transitory computer-readable medium, the computer program configured to cause at least one processor to perform operations comprising:
classifying portions of an electronic file using a trained machine learning based model, the classifications representing relative positions of the portions within sub-documents of the electronic file;
splitting the electronic file into the sub-documents based on the relative positions of the portions; and
outputting the sub-documents.

16. The computer program of claim 15, wherein the classifications representing the relative positions of the portions within the sub-documents of the electronic file comprise a classification representing a first portion of a sub-document, a classification representing a last portion of a sub-document, and a classification representing a portion of a sub-document between the first portion and the last portion.

17. The computer program of claim 15, wherein the portions of the electronic file correspond to pages of the electronic file.

18. The computer program of claim 15, wherein the trained machine learning based model comprises a trained deep learning model.

19. The computer program of claim 15, wherein the trained machine learning based model is based on one of a LSTM (long short-term memory) architecture, a Bi-LSTM (bi-directional LSTM) architecture, or a seq2seq (sequence-to-sequence) architecture.

20. The computer program of claim 15, the operations further comprising:
classifying the sub-documents using a classifier.

21. The computer-implemented method of claim 1, wherein the classifying, the splitting, and the outputting are performed by one or more computing devices implemented in a cloud computing system.

22. The apparatus of claim 10, wherein the apparatus is implemented in a cloud computing system.

23. The computer program of claim 15, wherein the at least one processor is implemented in one or more computing devices and the one or more computing devices are implemented in a cloud computing system.
